(19) United States
(12) Patent Application Publication
(10) Pub. No.: US 2003/0147327 A1
(43) Pub. Date: Aug. 7, 2003

(54) Holographic storage device with faceted surface structures and associated angle multiplexing method

(76) Inventors: Kevin R. Curtis, Longmont, CO (US); Brian M. King, Longmont, CO (US); Mark R. Ayres, Boulder, CO (US); Michael C. Tackitt, Lyons, CO (US)

Correspondence Address: Stephen C. Durant, Morrison & Foerster LLP, 425 Market St., San Francisco, CA, 94105-2482, US

(21) Appl. No.: 10/072,078

(22) Filed: Feb. 7, 2002

(51) Int. Cl. G11B 7/00

(52) U.S. Cl. 369/103

(57) ABSTRACT

A holographic storage apparatus is provided which comprise: a photorecording medium layer which includes a first side and a second side and which encompasses a plurality of volume holographic storage regions; a plurality of first surface structures disposed on the first side of the photorecording medium layer, respective first surface structures including respective first and second facets that upstand from the first side of the photorecording medium; and a corresponding plurality of second surface structures disposed on the second side of the photorecording medium layer, respective second surface structures including respective third facets that respectively upstand from the second side of the photorecording medium layer parallel to respective first facets of corresponding respective first surface structures; wherein each respective volume holographic storage region is disposed between a respective first surface structure and a respective corresponding second surface structure.

### BACKGROUND OF THE INVENTION

1. Field of the Invention

The invention relates in general to information storage media, and more particularly, to holographic storage media.

2. Description of the Related Art

Holography involves a process by which an image is stored as an interference pattern formed in a storage medium by the interference between a signal beam representing the image and a reference beam, and conversely, holography involves the process by which images are reconstructed from such interference patterns.

Holographic storage media can take advantage of the photorefractive effect described by David M. Pepper et al., in “The Photorefractive Effect,” Scientific American, October 1990 pages 62-74. Photorefractive materials have the property of developing light-induced changes in their index of refraction. This property can be used to store information in the form of holograms by establishing optical interference between two coherent light beams within the material. The interference generates spatial index of refraction variations through an electro-optic effect as a result of an internal electric field generated from migration and trapping of photoexcited electrons. While many materials have this characteristic to some extent, the term “photorefractive” is applied to those that have a substantially faster and more pronounced response to light wave energy.

Of more interest, are photopolymer recording materials. With these materials the variations in light intensity generate refractive index variations by light induced polymeration and mass transport. See Larson, Colvin, Harris, Schilling “Quantitative model of volume hologram formation in photopolymers,” J Appl. Phy. 84, 5913-5923 1996. Also Photochromatic materials can be used. These materials convert light variation into index variation through structural changes or isomerazations.

FIG. 1 illustrates the basic components of a holographic system 10. System 10 contains a modulating device 12, a photorecording medium 14, and a sensor 16. Modulating device 12 is any device capable of optically representing data in two-dimensions. Device 12 is typically a spatial light modulator (SLM) that is attached to an encoding unit which encodes data onto the modulator. Based on the encoding, device 12 selectively passes or blocks portions of an information-carrying signal beam 20 passing through device 12. In this manner, beam 20 is encoded with a data image. Device 12 can also be a reflective modulation device, a phase modulation device, or a polarization based modulation device. The image is stored by interfering the encoded signal beam 20 with a reference beam 22 at a location on or within photorecording medium 14. The interference creates an interference patterns (or hologram) that is captured within medium 14 as a pattern of, for example, varying refractive index. The photorecording medium, therefore, serves as a holographic storage medium. It is possible for more than one holographic image to be stored at a single location, or for a holographic image to be stored at a single location, or for holograms to be stored in overlapping positions, by, for example, varying the angle, the wavelength, or the phasecode of the reference beam 22, depending on the particular reference beam employed. It is also possible to multiplex (overlap) holograms by shift, correlation, or aperture multiplexing. Signal beam 20 typically passes through lens 30 before being intersected with reference beam 22 in the medium 14. It is possible for reference beam 22 to pass through lens 32 before this intersection. Once data is stored in medium 14, it is possible to retrieve the data by intersecting a reference beam 22 with medium 14 at the same location and at the same angle, wavelength, or phase at which a reference beam 22 was directed during storage of the data. The reconstructed data passes through lens 34 and is detected by sensor 16. Sensor 16, is for example, a charged coupled device or an active pixel sensor. Sensor 16 typically is attached to a unit that decodes the data.

A holographic storage medium includes the material within which a hologram is recorded and from which an image is reconstructed. A holographic storage medium may take a variety of forms. For example, it may comprise a film containing dispersed silver halide particles, photosensitive polymer films (“photopolymers”) or a freestanding crystal such as iron-doped LiNbO₃ crystal. U.S. Pat. No. 6,103,454, entitled RECORDING MEDIUM AND PROCESS FOR FORMING MEDIUM, generally describes several types of photopolymers suitable for use in holographic storage media. The patent describes an example of creation of a hologram in which a photopolymer is exposed to information carrying light. A monomer polymerizes in regions exposed to the light. Due to the lowering of the monomer concentration caused by the polymerization, monomer from darker unexposed regions of the material diffuses to the exposed regions. The polymerization and resulting concentration gradient creates a refractive index change forming a hologram representing the information carried by the light.

In volume holographic storage, a large number of holograms are stored in the same volume region of a holographic storage medium. Multiple holograms can be recorded in a recording medium using an exposure schedule that equalizes the amplitudes. There are several methods of holographic storage such as, angle multiplexing, fractal multiplexing, wave length multiplexing and phasecode multiplexing.

Angle multiplexing is a method of for storing a plurality of images within a single recording medium. Such angle multiplexing is described by P. J. van Heerden in, “Theory of Optical Information Storage In solids,” Applied Optics, Vol. 2, No. 4, page 393 (1963). Angle multiplexing generally involves maintaining a constant angle spectrum for an information carrying object beam, while varying the angle of a reference beam for each exposure. A different interference pattern thereby can be created for each of a plurality of different reference beam angles. Each different interference pattern corresponds to a different hologram. Angle multiplexing thus allows a larger number of holograms to be stored within a common volume of recording medium, thereby greatly enhancing the storage density of the medium.

U.S. Pat. No. 5,793,504 entitled HYBRID ANGULAR/SPATIAL HOLOGRAPHIC MULTIPLEXER, describes a method of angularly and spatially multiplexing a plurality of holograms within a storage medium. According to that patent, since diffraction efficiency of stored holograms varies, at least approximately, inversely with the square of the number of holograms stored, there is a limit to the number of holograms that can be stored within a given volume of a particular storage medium. Therefore, spatial multiplexing is employed to store different sets of holograms in different volume locations within a storage medium. The patent states that storing sets of holograms in spatially separated locations mitigates the problem of undesirable simultaneous excitation of holograms from different sets by a common reference beam. Spatial multiplexing typically does not increase the media's density, just its capacity.

While a large number of holograms can be stored within holographic storage media using a combination of angle multiplexing and spatial multiplexing techniques, there has been a need to further increase hologram storage density within such media. K. Curtis, et al., in “Method for holographic storage using peristrophic multiplexing,” Optics Letters, Vol. 19, No. 13, Jul. 1, 1994, describe a method of increasing hologram density by rotating the recording material comprising a thin-film photopolymer or, equivalently, by rotating beams used to record holograms in the material. During peristrophic multiplexing, the hologram may be physically rotated, with the axis of rotation being perpendicular to the film's surface every time a new hologram is stored. The rotation does two things. It shifts the reconstructed image away from the detector, permitting a new hologram to be stored and viewed without interference, and it can also cause the stored hologram to become non-Bragg matched. Peristrophic multiplexing can be combined with other multiplexing techniques such as angle multiplexing to increase the storage density and with spatial multiplexing to increase overall storage capacity of holographic storage systems. Thus, using a combination of peristrophic and angle multiplexing, for example, multiple stacks or sets of holograms can be created in the same volume location of a storage medium.

Unfortunately, there are shortcomings with these earlier multiplexing techniques. Generally, the larger the angle between a reference beam and an object beam, the greater the Bragg selectivity and therefore, the more holograms that can be stored within a given volume region. Bragg selectivity during angle multiplexing is described in Holographic Data Storage, pages 30-38, by H. J. Coufal, D. Psaltis, and G. T. Sincerbax, copyright 2000, Springer-Verlag, Berlin, Heidelberg, N.Y., which is expressly incorporated herein by this reference. Ordinarily, optimal Bragg selectivity is achieved with angles between the object and reference beams close to 90° internal to the material. However, as the angle between the object and reference beams is increased, the reference beam becomes incident upon the storage material at increasingly high angles relative to normal to the medium surface. A result of such glancing reference beam incidence is that the areas of the resultant holograms increase, thereby reducing the volume storage density. Basically, a beam incident upon the material at an increased angle illuminates a larger region of the material during hologram formation which results in a hologram that spans a larger volume which in turn results in reduced the hologram storage density. In addition, there exists a critical angle at which an incident reference beam will be completely reflected at the interface of the recording medium due to the indices of refraction of the medium and air.

A problem with peristrophic multiplexing in general, and with combining peristrophic multiplexing and angle multiplexing in particular, is that these techniques can require complex optics systems.

Thus, there has been a need for improvements in the storage of holograms. More specifically, there has been a need for increased holograph storage density. Furthermore, there has been a need for such multiplexing which does not require complex optics systems.

### SUMMARY OF THE INVENTION

In one aspect, the invention provides a holographic storage apparatus is provided which includes a photorecording medium which includes a first side and a second side and which encompasses a plurality of volume holographic storage regions. The photorecording medium may comprise photopolymer, photorefractive or photochromatic material. A plurality of first surface structures are disposed on the first side of the photorecording medium. The respective first surface structures include respective first and second facets that upstand from the first side of the photorecording medium and that are inclined at an angle between 50-130 degrees relative to one another. A corresponding plurality of second surface structures are disposed on the second side of the photorecording medium. The respective second surface structures include respective third facets that respectively upstand from the second side of the photorecording medium parallel to respective first facets of corresponding respective first surface structures. Each respective volume holographic storage region is disposed between a respective first surface structure and a respective corresponding second surface structure.

In another aspect, the present invention provides a method of recording holograms to such a holographic storage apparatus. An object signal beam is shined onto a respective first facet of a respective first surface structure while directing a reference beam shining onto a respective second facet of the respective first surface structure to be incident upon the respective second facet at different ones of a prescribed set of multiple discrete incidence angles during different recording times. As a result, multiple respective holograms can be recorded in a respective given holographic storage region disposed between the respective first and second surface structures.

In yet another aspect the present invention provides a method of reading stored holograms from such a holographic storage apparatus. A reference beam is shined onto a respective second facet of a respective first surface structure and while being directed to be incident upon the respective second facet at different ones of a prescribed set of multiple discrete incidence angles during the different image forming times. As a result, different respective image forming beams produced from multiple respective stored holograms shine out from a respective third facet of the respective second surface structure during the different image forming times.

Thus, increased hologram density is achieved by creating a stack of multiplexed holograms at a location in the media. Angle multiplexing can be combined with fractal or peristrophic multiplexing to further increase density. It is also possible to use phasecode multiplexing in this geometry as well. Storage capacity is increased by having multiple separate locations on the same media. Complex optics are not required since there are novel approaches to recording holograms to and reading holograms from the photorecording medium that mainly involve aligning the surface structures with the object beam and/or reference beam.

### BRIEF DESCRIPTION OF THE DRAWINGS

FIG. 1 is an illustrative drawing of a the basic components of a generalized holographic system;

FIG. 2 is an illustrative drawing of a top perspective view of a holographic storage media in accordance with an embodiment of the invention in which a photopolymer photorecording medium is sandwiched between first and second substrate layers which define a plurality of surface structures;

FIG. 3A is an illustrative drawing of a cross-sectional view of a portion of a first embodiment of the holographic storage apparatus constructed using a photorecording layer between top and bottom substrate layers as in the apparatus of FIG. 2;

FIG. 3B is an illustrative drawing showing a top perspective view of a representative first (top) surface structure of the holographic storage apparatus of FIG. 3A;

FIG. 3C is an illustrative drawing showing a top plan view of the representative first surface of FIG. 3C;

FIG. 4 is an illustrative drawing of a cross-sectional view of a portion of a second embodiment of the holographic storage apparatus constructed using a photorecording layer between top and bottom substrate layers as in the apparatus of FIG. 2;

FIG. 5 is an illustrative drawing of a cross-sectional view of a portion of a third embodiment of a holographic storage apparatus in accordance with the invention in which top and bottom surface structures are defined by the recording material;

FIG. 6 is an illustrative drawing of a cross-sectional view demonstrating angle multiplexing operation with a holographic storage apparatus in accordance with the invention showing relationships between object beam, reference beam and hologram read-out beam; and

FIG. 7 is a generalized block diagram of a layout of an angle multiplexing holographic system that can be used to record holograms to and read-out holograms from a holographic storage apparatus in accordance with the present invention.

### DETAILED DESCRIPTION OF THE PREFERRED EMBODIMENTS

The present invention provides a holographic storage apparatus and methods for writing to, reading from a holographic storage apparatus. The following description is presented to enable any person skilled in the art to make and use the invention. The embodiments of the invention are described in the context of particular applications and their requirements. These descriptions of specific applications are provided only as examples. Various modifications to the preferred embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

One embodiment of the invention comprises a photorecording layer that has a plurality of first surface structures disposed on a one (e.g., top) side of it, and that has a corresponding plurality of second surface structures disposed on an opposite (e.g., bottom) side of it. Each individual first surface structure includes at least two facets that are inclined relative to each other so as to upstand from the top side. Each individual second surface structure at least one facet that is inclined relative to and that upstands from the bottom side. Each first surface structure is associated with a corresponding second surface structure, and a corresponding volume region is disposed between such surface structures. The second surface structure may be shifted in position relative to the first structure so that the facets of the first and second surface structures are properly aligned relative to one another for hologram formation and read-out as described below.

A set of multiple holograms can be stored in association with each individual volume region associated with an respective first surface structure and with an associated respective second surface structure. Angle multiplexing is used to record multiple holograms within individual volume regions and to read-out stored holograms from such individual volume regions. During recording, an information carrying object beam shines on one facet of a given first surface structure, and a reference beam shines on the other facet of the given first surface structure. The first and second surface structures are transparent to the object beam and to the reference beam. The reference beam sweeps through a range of angles in prescribed increments in order to record multiple information bearing holograms in a volume region of the recording material associated with the first surface structure. During read-out from the volume region associated with the given first surface structure, a reference beam again shines through the other facet of the given first surface structure, and a reconstructed image beam produced from the stored hologram shines out through a facet of the corresponding second surface structure. The reference beam sweeps through the same range of angles in the same prescribed increments in order to read out information from multiple holograms recorded within a volume region associated with the given first and second surface structures. Other multiplexing techniques such as fractal and/or peristrophic can be combined with angle to further increase the density.

Spatial multiplexing techniques can be used to read/write using the surface structures which are dispersed about the top and bottom sides of the photorecording medium. This spatial separation of the surface structures from each other improves isolation of individual volume regions during recording of holograms and during reconstruction of holographically stored images. Spatial separation contributes to improved hologram quality by limiting simultaneous excitation of holograms stored formed in different volume regions associated with different sets of spatially separated corresponding top and bottom surface structures. Spatial separation allows for recording in one location not to effect the recording material at another location. For maximal density the facets should be as close together as possible.

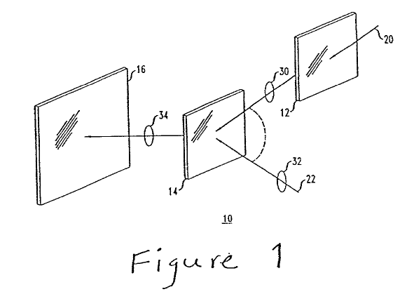

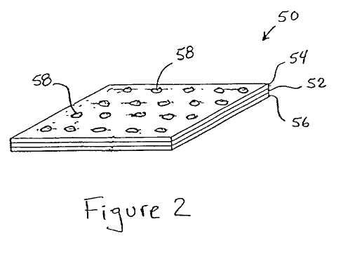

Referring to the illustrative drawing of FIG. 2, there is shown a perspective view of a holographic storage apparatus 50 in accordance with the one embodiment of the invention. The storage apparatus 50 includes a photorecording layer 52, also referred to as an actinic layer 52, disposed between first and second support layers 54, 56. An actinic material has the property that exposure of the material to certain light results in chemical changes to the material. The top and bottom layers 54, 56 are transparent to light used during holographic image recording and reconstruction. A plurality of top surface structures 58 are arrayed about the top layer 54. A corresponding plurality of bottom surface structures (not shown) are arrayed about the bottom layer 56. Exposure of the storage apparatus 50 to appropriate object and reference beams causes photochemical changes resulting in a stored diffraction pattern that constitutes a stored hologram. The storage apparatus 50 may serve in the role of the photorecording medium 14 of the illustrative holographic system 10 of FIG. 1.

In a present embodiment, the preferred photorecording material 52 is photopolymer comprising a sentizer, monomers, and a matrix, and the first and second substrate layers 54, 56 are glass or plastics such as polycarbonate or PMMA or other material used for optical disk substrates. The first and second layers 54, 56 need not be formed from identical materials provided that their indices of refraction fall within the required range described herein. Alternatively, the recording material itself can be formed into the shape. More specifically, the holographic storage media 50 is formed using the materials and techniques of the type disclosed in U.S. Pat. No. 5,874,187 issued to Colvin et al.; in U.S. Pat. No. 5,932,045 issued to Campbell et al.; and in, U.S. Pat. No. 6,103,454 issued to Dhar et al. Each of these three patents is expressly incorporated herein by this reference.

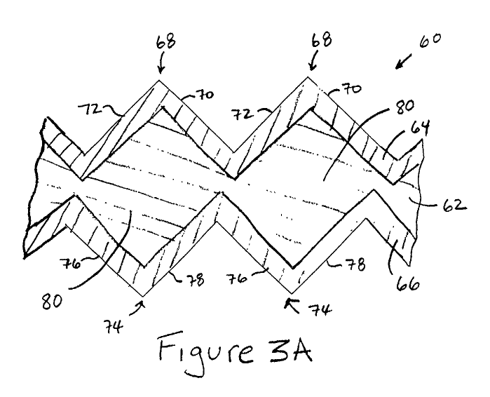

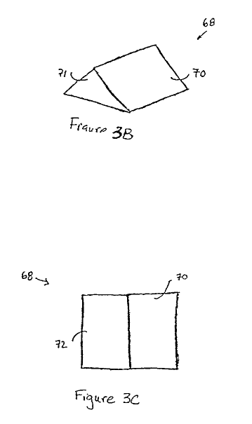

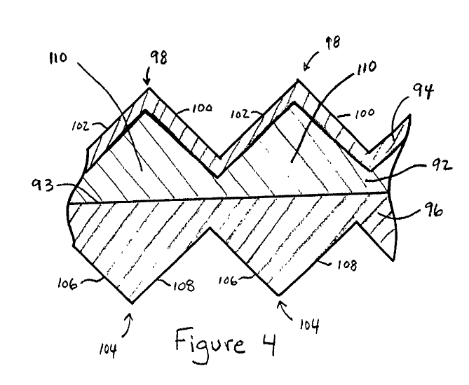

The illustrative drawing of FIG. 3A shows a cross-sectional view of one embodiment 60 of the general type of holographic storage media 50 of FIG. 2. A photorecording material layer 62 is disposed between a first (top) substrate layer 64 and a second (bottom) substrate layer 66. The first substrate layer 64 defines a plurality of first (top) surface structures 68. Each respective first surface structure 68 comprises at least two facets, a respective first (top) facet 70 and a respective second (top) facet 72. Each first facet 70 and each second facet 72 has an outer surface facing away from the photorecording material layer 62, and each first facet 70 and each second facet 72 has an inner surface facing toward the photorecording material 62. Similarly, the second (bottom) substrate layer 66 defines a plurality of second (bottom) surface structures 74. Each respective second surface structure 74 comprises at least two facets, a respective third (bottom) facet 76 and a respective fourth (bottom) facet 78. Each third facet 76 and each fourth facet 78 has an outer surface facing away from the photorecording material layer 62, and each third facet 76 and each fourth facet 78 has an inner surface facing toward the photorecording material 62.

FIG. 3B is an illustrative top perspective view of a representative first (top) surface structure 68 showing a first facet 70 and one sidewall 71. FIG. 3C is a top plan view of the representative first surface structure 68 showing its first and second facets 70, 72. Each individual first surface structure 68 is defined by its first and second inclined facets 70, 72 and its vertical sidewalls. Only one of two sidewalls 71 is shown in FIG. 3B. Each second (bottom) surface structure 74 has the substantially the same overall shape as its corresponding first surface structure 68. However, the first surface structures 68 upstand in one direction, while the second surface structures 74 upstand in an opposite direction. Facets 71 and 72 maybe of different length and inclined at different angles from the general surface normal. They need not have identical shapes, and they need not have identical inclinations relative to the surface normal.

It will be appreciated that the terms top and bottom are used herein only for convenience in distinguishing one side of a storage apparatus from the other side. The terms top and bottom are not intended to be otherwise limiting. For instance, the terms right and left could have been used to describe the same relative positions of the sides of the apparatus. Similarly, the terms inner and outer are used herein only for convenience in distinguishing the directions faced by the different facet surfaces relative to the photorecording material. These terms are intended only to describe the relative positions of various portions of the apparatus and are not otherwise intended to be limiting.

The first (top) surface structures 68 defined by the first (top) substrate layer 64 upstand from that first substrate layer. More specifically, there is an angle between 50-130 degrees between inward-facing surfaces of the first and second (top) facets 70, 72 of the first substrate layer 64. The inward facing surface face toward the photorecording material 62. There is an obtuse angle (>90°) between the outward-facing surfaces and the outer point of intersection of the first and second facets 70, 72 of the first substrate layer 64. The outward facing surfaces face away from the photorecording material 62. Similarly, the second (bottom) surfaces structure 74 defined by the second (bottom) substrate layer 66 upstand from that second surface layer 66. Specifically, there is an angle between 50-130 degrees between the inner-facing surfaces of the first and fourth (bottom) facets 76, 78 of the second substrate layer 66. There is an obtuse angle between the outward-facing surfaces of the third and fourth facets 76, 78 of the second substrate layer 66 facing away from the photorecording material 62.

The first surface structures 68 define, at least in part, adjacent volume regions 80. More specifically, the first and second facets 70, 72 that upstand from the first substrate layer 64 help define volume regions 80 disposed at least partially between such first and second facets 70, 72. The defined volume regions 80 are filled with the photorecording material 62. The first and second facets of the first surface structures 68 are transparent to object and reference beams. An information carrying object beam and corresponding reference beam can be transmitted through the first and second facets 70, 72 of a given first surface structure 68 so as to form holograms within a volume region 80 adjacent to that given first surface structure 68. Conversely, a reference beam can be shined through a second facet associated with the given first surface structure 68 in order to read-out reconstructed images from holograms recorded in the volume region 80 adjacent to that given first surface structure 68.

Individual respective second surface structures 74 correspond to individual respective first surface structures 68. Similarly, individual respective volume regions 80 adjacent to individual respective first (top) surface structures 68 also are adjacent to corresponding individual respective second (bottom) surface structures 74. That is, respective corresponding first and second surface structures 68, 74 are adjacent to the same respective volume region. 80. Thus, each respective volume region 80 is adjacent to both a respective first surface structure 68 and to that first surface structure's respective corresponding second surface structure 74. The desire is to achieve the maximum clear aperature for the optical beams with the smallest facet sizes.

Respective inner-facing and outer-facing surfaces of respective first (top) facets 70 of respective first (top) surface structures 68 are parallel to respective inner-facing and outer-facing surfaces of respective third (bottom) facets 76 of respective corresponding second surface structures 74. Likewise, respective inner-facing and outer-facing surfaces of respective second (top) facets 72 of respective first (top) surface structures 68 are parallel to respective inner-facing and outer-facing surfaces of respective fourth (bottom) facets 76 of respective corresponding second surface structures 74.

In operation, during recording of a hologram to a given volume region 80 associated with a given first surface structure 68, an information carrying object beam is incident upon a first facet 70 of the given first surface structure. Conversely, during reconstruction of an image from a hologram recorded in the given volume region 80 an image forming beam exits a third facet 76 of a second surface structure 74 corresponding to the given first surface structure 68. During both recording to and reconstruction from the given volume region, a reference beam is incident upon the second facet 72 of the given first surface structure 68.

In a present embodiment of the invention it is desired that an object beam entering a first facet 70 follow a path that is parallel to that of a reconstructed beam that emerges from a corresponding third facet 76. The materials used in the photorecording material layer 62 and in the first and second layers 64, 66 are selected to have close indices of refraction. In a present photopolymer embodiment, the index of refraction of the photocrecording medium 62 is approximately 15, and the index of refraction of the first and second layers 64, 66 is constrained to be within 20% of the recording materials index. Thus parallelism of respective outer-facing surfaces of respective first (and third) facets 70, 76 of corresponding first and second surface structures 68, 74 is much more important than parallelism of respective inner-facing surfaces of the first (first and third) facets 70, 76 and is more important than parallelism of inner-facing and outer-facing surfaces of second (and fourth) facets 72, 78 of corresponding first and second surface structures 68, 74.

One reason for the requirement that the angle between adjacent facets to be 50-130 degrees and for the indices of refraction of the recording medium and the support layers to be within about 20% is so that the object and reference beams can be directed to interfere with each other within the medium so as to create a stack of holograms through angle multiplexing. It is a matter of design choice as to how the indices of refraction and the angle between facets are selected to obtain the desired results. However an objective of one embodiment is to maximize the number of holograms that can be stored which is determined by selectivity. It is noted that by making the beam diameter smaller, it is possible to increase the sweep range with a sacrifice of some selectivity. Another reason for the above limitation on the indices of refraction is to limit reflections from the recording medium interface, for example. Such reflections constitute unwanted noise.

Ideally, such outer-facing surfaces of respective corresponding first (and third) facets 70, 76 should be optically flat, and the “wedge” between them should be close to 0°. In a present embodiment, optically flat means flat to within about 1/2(λ)/mm, and such corresponding outer-facing surfaces of corresponding first (and third) facets 70, 76 are parallel to within 1/2(λ)/mm. Where λ is the wavelength of light used to record holograms to and to read-out holograms from a volume region 80 adjacent to respective first and second surface structures 68, 74 defined at least in part by such first (and third) facets 70, 76.

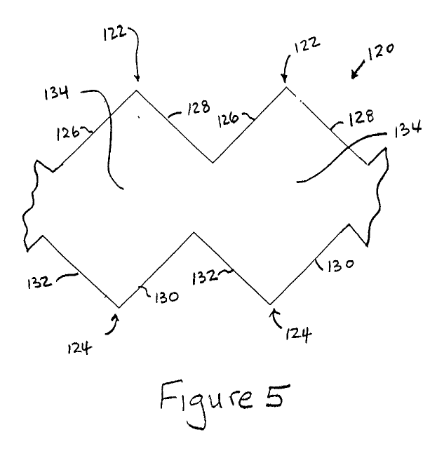

The illustrative drawing of FIG. 4 shows a cross-sectional view of a second embodiment 90 of the general type of holographic storage media 50 of FIG. 2. A photorecording layer 92 is disposed between a first (top) substrate layer 94 and a second (bottom) substrate layer 96. In contrast to the first embodiment of FIG. 3A, the second embodiment of FIG. 3A has a substantially planar interface 93 between the photorecording material 92 and the second substrate layer 96. The first substrate layer 94 defines a plurality of first (top) surface structures 96. Each respective first surface structure 98 comprises at least two facets, a respective first (top) facet 100 and a respective second (top) facet 102. Each first facet 100 and each second facet 102 has an outer surface facing away from the photorecording material layer 92, and each first (top) facet 100 and each second (top) facet 102 has an inner surface facing toward the photorecording material 92. Similarly, the second substrate layer 96 defines a plurality of second (bottom) surface structures 104. Each respective second surface structure 104 comprises at least two facets, a respective third (bottom) facet 106 and a respective fourth (bottom) facet 108. Each third facet 106 and each fourth facet 108 has an outer surface facing away from the photorecording material layer 92. However, the inner surface of the second layer 96 forms a substantially planar interface 93 with the photorecording medium 92.

The first surface structures 98 defined by the first substrate layer 94 upstand from that first substrate layer 94. There is an angle between 50-130 degrees between inward-facing surfaces of the first and second facets 100, 102 of the first substrate layer 94. The inward facing surface face toward the photorecording material 92. There is an obtuse angle between the outward-facing first and second facets 100, 102 of the first substrate layer 94. The outward facing surfaces face away from the photorecording material 92. The second surface structures 104 defined by the second substrate layer 96 upstand from that second surface layer 96. The overall shape of the first and second surface structures of FIG. 4 is the same as the surface structures illustrated in FIGS. 3B and 3C. Unlike the embodiment first embodiment illustrated in FIG. 3A, however, the second embodiment illustrated in FIG. 4 does not include inward-facing third and fourth facet surfaces adjacent to the photorecording material layer 92. Rather, in the second embodiment, there is a generally planar interface of the photorecording layer 92 and the second substrate layer 96. Like the first embodiment, however, there is an obtuse angle between outward-facing surfaces of the third and fourth facets 106, 108 of the second substrate layer 96 facing away from the photorecording material 92.

Also, like the first surface structures 68 of the first embodiment of FIG. 3A, the first surface structures 98 of the second embodiment of FIG. 4 define adjacent volume regions 110. In particular, the first and second facets 100, 102 that upstand from the first substrate layer 94 of the second embodiment 90, define volume regions 110 disposed at least partially between such first and second facets 100, 102. The defined volume regions 110 are filled with the photorecording material 92. An information carrying object beam and corresponding reference beam can be transmitted through the first and second facets 100, 102 of a given first surface structure 98 so as to form holograms within a volume region 110 adjacent to that given first surface structure 98. Conversely, a reference beam can be shined through a second facet associated with the given first surface structure 98 in order to read-out holograms recorded in the volume region 110 adjacent to that given first surface structure 98.

Individual respective second surface structures 104 correspond to individual respective first surface structures 98. Similarly, individual respective volume regions 110 adjacent to individual respective first surface structures 98 also are adjacent to corresponding individual respective second surface structures 104. That is, respective corresponding first and second surface structures 98, 104 are adjacent to the same respective volume region 110. Thus, like the first embodiment shown in FIG. 3A, each respective volume region 110 of the second embodiment of FIG. 4 is adjacent to both a respective first surface structure 98 and to that first surface structure's respective corresponding second surface structure 104.

Respective outward-facing surfaces of respective first facets 100 of respective first surface structures 98 are parallel to respective corresponding outward-facing surfaces of respective third facets 106 of respective corresponding second surface structures 104. Likewise, respective outward-facing surfaces of respective second facets 102 of respective first surface structures 98 are parallel to respective outward-facing surfaces of respective corresponding fourth facets 106 of respective corresponding second surface structures 104. Ideally, in a present embodiment, the outward-facing surfaces of the first facets 100 and the outward-facing surfaces of the facets 106 are optically flat and parallel to within about 1/2(λ)/mm.

On the one hand, for similarly dimensioned surface structures, the embodiment of FIG. 3A results in a relatively greater volume of photopolymer material within each volume region 80 as compared with volume regions 110 of the embodiment of FIG. 4. The presence of more photopolymer can result in better hologram quality or higher hologram diffraction efficiency. On the other hand, the embodiment of FIG. 4 can be easier to manufacture than the embodiment of FIG. 3A. The substantially flat interface 93 between the photorecording layer 92 and the second substrate layer 96 can promote ease of manufacture by making it easier to get photopolymer inserted in close against the substrate layers 94, 96. Moreover, the embodiment of FIG. 4 may be physically stronger and less brittle than the embodiment of FIG. 3A due to the increased overall volume and thickness of the second substrate layer 96.

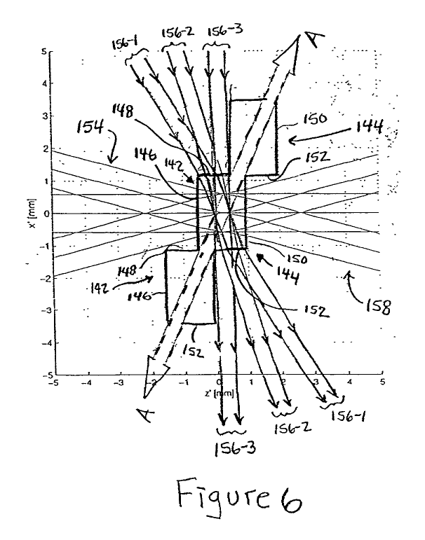

The illustrative drawing of FIG. 5 shows a cross-sectional view of a third embodiment 120 of a holographic storage apparatus. Unlike the first and second embodiments of FIGS. 3A and 4, the third embodiment does not comprise a photorecording layer sandwiched between top and bottom substrate layers having top and bottom surface structures formed in them. Rather, the third embodiment 120 of FIG. 5 comprises a unitary structure which itself both defines a photorecording medium 120 defining first (top) and second (bottom) surface structures 122, 124 which itself serves as the photorecording material.

Each respective first surface structure 122 comprises at least two facets, a respective first outward-facing facet 126 and a respective second outward-facing facet 128. Each respective second surface structure 124 comprises at least two facets, a respective third outward-facing facet 130 and a respective fourth outward-facing facet 132. There is an obtuse angle between the outward-facing first and second facets 126, 128. There is an obtuse angle between outward-facing surfaces of the third and fourth facets 130, 132.

Like the first surface structures 68, 96 of the first and second embodiments 60, 90 of FIGS. 3A and 4, the first surface structures 122 of the third embodiment of FIG. 5 define adjacent volume regions 134. The first and second facets 126, 128 of respective first surface structures 122 define volume regions 134 disposed at least partially between such first and second facets 126, 128. An information carrying signal beam and corresponding reference beam can be transmitted through the first and second facets 126, 128 of a given first surface structure 122 so as to form holograms within a volume region 134 adjacent to that given first surface structure 122. Conversely, a reference beam can be shined through a second facet associated with the given first surface structure 128 in order to read-out holograms recorded in the volume region 134 adjacent to that given first surface structure 122.

Respective outer-facing surfaces of respective first facets 126 of respective first surface structures 122 are parallel to respective corresponding outer-facing surfaces of respective third facets 130 of respective corresponding second surface structures 124. Likewise, respective outer-facing surfaces of respective second facets 128 of respective first surface structures 122 are parallel to respective outer-facing surfaces of respective corresponding fourth facets 132 of respective corresponding second surface structures 124. Ideally, as with the first and second embodiments of FIGS. 3A and 4, the outward-facing surfaces of the first facets 122 and the outward-facing surfaces of the third facets 124 of the third embodiment of FIG. 5 are optically flat and parallel to within about 1/2(λ)/mm. This can be fabricated by injection molding or curing the material in situ with the corresponding molds designed to produce the correct surface structure.

FIG. 6 is an illustrative cross-sectional drawing of a holographic storage media 140 in accordance with the invention. The media 140 can be implemented as any one of the first, second or third illustrative embodiments of FIGS. 3-5. Three illustrative first (top) surface structures 142 are shown (to the left side of the drawing), and three corresponding second (bottom) surface structures 144 are shown (to the right side of the drawing). First surface structures 142 include respective first and second facets 146, 148. Second (bottom) surface structures 144 include respective third and fourth facets 150, 152. Each first surface structure 142 is associated with a corresponding second surface structure 144. Each respective first surface structure 142 and its respective corresponding second surface structure 144 encompasses, at least partially, a respective volume region in which multiple holograms can be recorded using angle multiplexing.

The multiple holograms stored in a given volume region are spatially separated from other holograms stored in other volume regions. The surface structures that demarcate a given volume region spatially separate it from other volume regions. More specifically, a given volume region demarcated by the facets of a given first upstanding surface structure 142 and by the facets of a corresponding given second upstanding surface structure 144 is spatially separated from adjacent volume regions demarcated by facets of those adjacent volume regions.

During recording of hologram, both an information carrying object beam 154 and a reference beam 156 shine on a given first surface structure. The reference beam 156 can be swept through a range of prescribed angles to store multiple holograms through an angle multiplexing technique. More particularly, during recording, the object beam 154 shines on a first facet 142 of the given first surface structure 142, and the reference beam 156 shines on a second facet 148 of the given first surface structure 142. The object beam 154 and the reference beam 156 interfere within a given volume region associated with the given first surface structure 142 so as to create index of refraction variations that constitute a stored hologram representing the information carried by the object beam 154. It will be appreciated by persons skilled in the art that the reference beam must remain incident upon the second facet 148 for an amount while the object beam is incident upon the first facet 142, for at least an amount of time, referred to herein as the recording time, sufficient for interference between the object and reference beams to form a hologram.

During read-out of that same stored hologram, a reference beam 156 shines on a given first surface structure, and an information carrying reconstructed image beam 158 shines outward from a given second surface structure 144 associated with the given first surface structure 142. Specifically, during reading, the reference beam 156 shines on a second facet of a given first surface structure 142, and a reconstructed image beam 158 shines out from a third facet 150 of a given second surface structure 144 corresponding to the given first surface structure 142.

Angle multiplexing permits multiple holograms to be stored within a given volume region by changing the angle of incidence of the reference beam 156. The illustrative drawings of FIG. 6 shows three different reference beam paths 156-1, 156-2 and 156-3, each associated with a different angle of incidence between the reference beam 156 and the second facet 148 of the center first surface structure 148 shown in FIG. 6.

It will be appreciated that in a present embodiment, the reference beam 156 is incident on the second facet 148 at only one angle of incidence at a time. More particularly, a different hologram can be written and read out for each different prescribed angle of incidence of the reference beam. The minimum angular separations between holograms in a given volume region depends upon Bragg selectivity as discussed in Holographic Data Storage. Thus, there is a discrete reference beam incidence angle associated with each hologram. The same discrete reference beam incidence angle that is used to record an image as a hologram is later used to reconstruct that image from the stored hologram.

By way of example, assume that during recording of a first hologram, the reference beam 156 follows a first path 156-1 which is incident upon the second facet of the center first top surface structure 142 at a first angle during a first recording time interval. During recording of the first hologram, the object beam 154 carries first information to be represented by that first hologram. The reference beam shines on a second facet 148 of the center first surface structure 142, and the first information carrying object beam 154 shines on the first surface of the center first surface structure 142 for at least an amount of time, the recording time, sufficient to create the index of refraction variations associated with the first hologram. Note that the intersecting lines within the center surface structure 142 and its corresponding second surface structure 144 represent the interference between the reference beam 156 and the object beam 154. Next, for example, assume that during recording of a second hologram, the reference beam, following the second path 156-2 and incident at the second angle, shines on the second facet 148 during a second recording time interval, and the object beam 154 carrying second information shines on the first (top) facet 146 for an amount of time sufficient to create the second hologram during the second recording time interval. Continuing with the example, assume that during recording of a third hologram, the reference beam, following the third path 156-3 and incident at the third angle, shines on the same second facet 148 during a third recording time interval, and the object beam 154 carrying third information shines on the same first facet 146 for an amount of time sufficient to create the third hologram during the third recording time interval. In this manner, the first, second and third holograms are recorded using angle multiplexing, such that each of the three holograms is associated with a different reference beam angle of incidence.

By way of further example, respective ones of the three stored holograms are read-out of the volume region associated with the center first and second (top and bottom) surface structures 142, 144 by respectively shining the reference beam 156 on the second facet 148 at the same incidence angle used to store the respective hologram. More specifically, for example, in order to read-out the first hologram, the reference beam 156 is shined along the first path 156-1 such that the reference beam 156 is incident on the second facet 148 at the first incidence angle during a first image forming time interval. A reconstructed image beam 158 carrying the first information shines out the third facet 150 in response to the reference beam 156 incident at the first incidence angle during the first image forming time interval. Similarly, a reconstructed image beam 158 carrying the second information shines out the facet 150 in response to a reference beam 156 incident shining along the second path 156-2 and incident on the second (top) facet 148 at the second incidence angle during a second image forming time interval. Likewise, a reconstructed image beam 158 carrying the third information shines out the third facet 150 in response to a reference beam 156 incident shining along the third path 156-3 and incident on the second facet 148 at the third incidence angle during a third image forming time interval.

With respect to each of FIGS. 2-6, it will be appreciated that spatial multiplexing is achieved by storing different sets of multiple holograms in association with different volume regions that are spaced apart from each other. For example, referring to FIG. 6, in order to record and/or read-out from different spaced apart volume regions of the storage apparatus 140 associated with other first (top) and corresponding second (bottom) surface structures 142, 144, the position of the those volume regions relative to the optics and other components (not shown) used to produce the object beam 154 and the reference beam 156 and used to receive the holographic output beam 158 must be changed so that such beams are incident as required for angle multiplexing. For instance, in a present embodiment the apparatus 140 moves relative to such optics and other components along axis A-A in order to position different first and second surface structures and associated volume regions relative to such various optics and other components.

It will be further appreciated that the surface structures may be arrayed in any of numerous different patterns. For instance, they may be arrayed in a generally circular pattern if the storage apparatus is implemented in a disk format. Alternatively, they may be arrayed in a generally rectangular pattern of rows and columns if the storage apparatus is implemented in a card format.

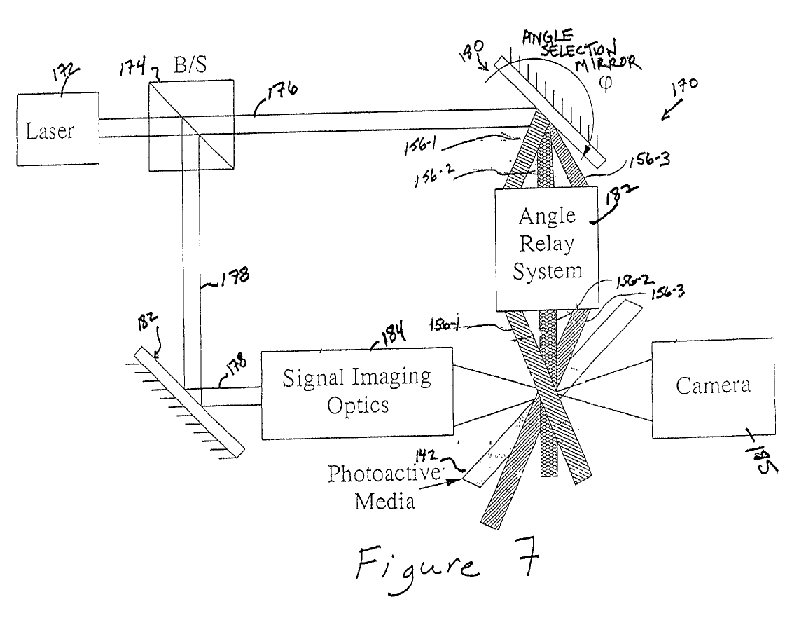

FIG. 7 is a generalized block diagram of a layout of an angle multiplexing holographic system 170 that can be used to record holograms to and read-out holograms from the holographic storage apparatus 112 of FIG. 6. It will be appreciated, however, that the system 170 can be used with any of the embodiments of FIGS. 2-6 of the present invention.

Referring to FIG. 7, a laser 172 serves as a coherent light source. A beam splitter 174 splits the source light into first and second beams 176, 178 which provide light for reference and object beams, respectively. The first beam 176 is incident upon adjustable angle selection reflecting surface 180. The second beam 178 is incident upon angle reflecting surface 182. The adjustable angle reflecting surface varies the angle of reflection of the first beam 176 so as to provide a reference beam at different prescribed angles at different times recording and read-out. As explained above, each prescribed different angle corresponds to a different stored hologram. More specifically, at a first time, the reference beam can be provided at a first angle corresponding to a first path 156-1. At a second time, the reference beam can be provided at a second angle corresponding to a second path 156-2. At a third time, the reference beam can be provided at a third angle corresponding to a third path 156-3. The reference beam, whether following the first, second or third path, is provided to an angle relay system 182. The angle relay system 182 ensures that the reference beam is incident upon the same location of a given second facet of a holographic storage medium 142 regardless of the path it follows and regardless of its angle of incidence upon such given second facet. During recording of holograms, the signal imaging optics 184 receives the second beam 178 and outputs an object beam 186 modulated with information to be stored as a hologram in the holographic storage apparatus 142. During reconstruction of recorded holograms a sensing device, a camera 185 in this case, receives a reconstructed image beam from the holographic storage apparatus 142. It will be appreciated that a system (not shown) which forms no part of the invention is required to achieve spatial multiplexing which involves moving the storage apparatus 142 so as to bring different surface structures and corresponding volume regions into alignment with reference and object beams.

Various modifications to the preferred embodiments can be made without departing from the spirit and scope f the invention. Thus, the foregoing description is not intended to limit the invention which is described in the appended claims.

1. A holographic storage apparatus comprising:
a photorecording medium layer which includes a first side and a second side and which encompasses a plurality of volume holographic storage regions;
a plurality of first surface structures disposed on the first side of the photorecording medium layer, respective first surface structures including respective first and second facets that upstand from the first side of the photorecording medium layer and that are inclined at an angle of 50°-130° relative to one another; and
a corresponding plurality of second surface structures disposed on the second side of the photorecording medium layer, respective second surface structures including respective third facets that respectively upstand from the second side of the photorecording medium layer parallel to respective first facets of corresponding respective first surface structures;
wherein each respective volume holographic storage region is disposed between a respective first surface structure and a respective corresponding second surface structure.

2. The apparatus of claim 1,
wherein each respective first surface structure is disposed in relation to its respective corresponding second surface structure such that,
multiple respective holograms can be recorded in a respective given holographic storage region disposed between such given holographic storage region's respective first and second surface structures by shining an object signal beam onto a respective first facet of the respective first surface structure while directing a reference beam shining onto a respective second facet of the respective first surface structure to be incident upon the respective second facet at different ones of a prescribed set of multiple discrete incidence angles during different recording times, wherein each discrete incidence angle corresponds to one of the multiple respective holograms; and
subsequently, multiple respective image forming beams can be produced during different image forming times from the multiple respective stored holograms and to shine out from a respective third facet of the respective second surface structure by directing a reference beam shined onto the respective second facet of the respective first surface structure to be incident upon the respective second facet at different ones of the prescribed set of multiple discrete incidence angles during the different image forming times.

3. The apparatus of claim 1,
wherein respective outer surfaces of respective first and third facets of respective first and third surface structures are optically flat.

4. The apparatus of claim 1,
wherein respective second surface structures include respective fourth facets that upstand from the second side of the photorecording medium layer such that respective first and second facets are inclined at an angle between 50-130 degrees relative to one another; and
wherein respective second and fourth facets of respective corresponding respective first and second surface structures are parallel to each other.

5. The apparatus of claim 1 in a disk format.

6. The apparatus of claim 1 in a card format.

7. The apparatus of claim 1 wherein the photorecording material includes photopolymer material.

8. The apparatus of claim I wherein the photorecording material includes photorefractive material.

9. The apparatus of claim 1 wherein the photorecording material includes photochromatic material.

10. The apparatus of claim 1 further including:
a first layer that is disposed on the first side of the photorecording medium layer and that includes the plurality of first surface structures; and
a second layer that is disposed on the second side of the photorecording medium layer and that includes the plurality of second surface structures.

11. The apparatus of claim 1,
wherein an index of refraction of the first layer is within 20% of an index of refraction of the photorecording medium; and
wherein an index of refraction of the second layer is within 20% of an index of refraction of the photorecording medium.

12. A holographic storage apparatus comprising:
a photorecording medium layer which includes a first side and a second side and which encompasses a plurality of volume holographic storage regions;
a first layer that is disposed on the first side of the photorecording medium layer and that includes a plurality of respective first surface structures with respective first surface structures including respective first and second facets with surfaces facing toward the photorecording medium layer inclined at an angle of 50°-130° or less relative to one another; and
a second layer that is disposed on the second side of the photorecording medium layer and that includes a corresponding plurality of respective second surface structures with respective third and fourth facets with surfaces facing toward the photorecording medium layer inclined at an angle of 50°-130° relative to one another;
wherein each respective volume holographic storage region is disposed between a respective first surface structure and a respective corresponding second surface structure.

13. The apparatus of claim 12,
wherein respective first surface structures include respective first facets with respective outer surfaces facing away from the photorecording medium layer;
wherein respective second surface structures include respective third facets with respective outer surfaces facing away from the photorecording medium layer; and
wherein respective outer surfaces of respective third facets are parallel to respective outer surfaces of corresponding respective first facets.

14. The apparatus of claim 12,
wherein respective first surface structures include respective first facets with respective outer surfaces facing away from the photorecording medium layer and include respective second facets with respective outer surfaces facing away from the photorecording medium layer;
wherein respective second surface structures include respective third facets with respective outer surfaces facing away from the photorecording medium layer and include respective fourth facets with respective outer surfaces facing away from the photorecording medium layer;
wherein respective outer surfaces of respective third facets are parallel to respective outer surfaces of corresponding respective first facets; and
wherein respective outer surfaces of respective fourth facets are parallel to respective outer surfaces of corresponding respective second facets.

15. The apparatus of claim 12,
wherein respective outer surfaces of respective first and third facets of respective first and third surface structures are optically flat.

16. The apparatus of claim 12,
wherein an index of refraction of the first layer is within 20% of an index of an index of refraction of the photorecording medium; and
wherein an index of refraction of the second layer is within 20% of an index of an index of refraction of the photorecording medium.

17. The apparatus of claim 12,
wherein the photorecording medium layer comprises a photopolymer material;
wherein the first layer serves as a support layer formed of a material with an index of refraction within 20% of that of the photo recording material; and
wherein the second layer serves as a support layer formed of a material with an index of refraction within 20% of that of the photo recording material.

18. A holographic storage apparatus comprising:
a photorecording medium layer which includes a first side and a second side and which encompasses a plurality of volume holographic storage regions;
a first layer that is disposed on the first side of the photorecording medium layer and that includes a plurality of respective first surface structures with respective first surface structures including respective first and second facets with respective inner and outer surfaces, wherein respective inner surfaces facing toward the photorecording medium layer are inclined at an angle of 50°-130° relative to one another; and
a second layer that is disposed on the second side of the photorecording medium layer and that includes a corresponding plurality of respective second surface structures with respective third and fourth facets with respective outer surfaces facing away from the photorecording medium, wherein respective outer surfaces of respective third facets are parallel to respective outer surfaces of corresponding respective first facets;
wherein each respective volume holographic storage region is disposed between a respective first surface structure and a respective corresponding second surface structure.

19. The apparatus of claim 18,
wherein respective outer surfaces of respective fourth facets are parallel to respective outer surfaces of corresponding respective second facets.

20. The apparatus of claim 18,
wherein an interface between the photorecording medium layer and the second layer is substantially planar.

21. The apparatus of claim 18,
wherein respective outer surfaces of respective first and third facets of respective first and third surface structures are optically flat.

22. The apparatus of claim 18,
wherein an index of refraction of the first layer is within 20% of an index of refraction of the photorecording medium; and
wherein an index of refraction of the second layer is within 20% of an index of refraction of the photorecording medium.

23. The apparatus of claim 18,
wherein the photorecording medium layer comprises a photopolymer material;
wherein the first layer serves as a support layer formed of a material with an index of refraction within 20% of that of the photo recording material; and
wherein the second layer serves as a support layer formed of a material with an index of refraction within 20% of that of the photo recording material.

24. A method of recording holograms within a holographic storage apparatus comprising:
providing a photorecording medium layer which includes a first side and a second side and which encompasses a plurality of volume holographic storage regions respectively disposed between respective first surface structures and respective corresponding second surface structures, each respective first surface structure including respective first and second facets that upstand from the first side of the photorecording medium layer, and each respective corresponding second surface structure including a respective third facet that respectively upstands from the second side of the photorecording medium layer parallel to a respective first facet of a corresponding respective first surface structure; and
shining an object signal beam onto a respective first facet of a respective first surface structure while directing a reference beam shining onto a respective second facet of the respective first surface structure to be incident upon the respective second facet at different ones of a prescribed set of multiple discrete incidence angles during different recording times.
whereby multiple respective holograms can be recorded in a respective given holographic storage region disposed between the respective first and second surface structures.

25. The method of claim 24 further including:
repeating the step of directing for different respective first surface structures and corresponding respective second surface structures.

26. A method of reading stored holograms from a holographic storage apparatus comprising:
providing a photorecording medium layer which includes a first side and a second side and which encompasses a plurality of volume holographic storage regions respectively disposed between respective first surface structures and respective corresponding second surface structures, each respective first surface structure including respective first and second facets that upstand from the first side of the photorecording medium layer, and each respective corresponding second surface structure including a respective third facet that respectively upstands from the second side of the photorecording medium layer parallel to a respective first facet of a corresponding respective first surface structure; and
directing a reference beam shined onto a respective second facet of the respective first surface structure to be incident upon the respective second facet at different ones of a prescribed set of multiple discrete incidence angles during the different image forming times;
whereby different respective image forming beams produced from multiple respective stored holograms shine out from a respective third facet of the respective second surface structure during the different image forming times.

27. The method of claim 26 further including:
repeating the step of directing for different respective first surface structures and corresponding respective second surface structures.

28. A method of accessing a holographic storage apparatus comprising:
providing a photorecording medium layer which includes a first side and a second side and which encompasses a plurality of volume holographic storage regions respectively disposed between respective first surface structures and respective corresponding second surface structures, each respective first surface structure including respective first and second facets that upstand from the first side of the photorecording medium layer, and each respective corresponding second surface structure including a respective third facet that respectively upstands from the second side of the photorecording medium layer parallel to a respective first facet of a corresponding respective first surface structure;
directing a reference beam shined onto a respective second facet of the respective first surface structure to be incident upon the respective second facet at different ones of the prescribed set of multiple discrete incidence angles during the different image forming times;
whereby different respective image forming beams produced from multiple respective stored holograms shine out from a respective third facet of the respective second surface structure during the different image forming times; and
subsequently, directing a reference beam shined onto a respective second facet of the respective first surface structure to be incident upon the respective second facet at different ones of the prescribed set of multiple discrete incidence angles during the different image forming times;
whereby different respective image forming beams produced from multiple respective stored holograms shine out from a respective third facet of the respective second surface structure during the different image forming times.
